(19) United States
(12) Patent Application Publication
(10) Pub. No.: US 2023/0090398 A1
(43) Pub. Date: Mar. 23, 2023

(54) SYSTEMS AND METHODS FOR GENERATING SYNTHETIC DATA USING FEDERATED, COLLABORATIVE, PRIVACY PRESERVING MODELS

(71) Applicant: JPMORGAN CHASE BANK, N.A., New York, NY (US)

(72) Inventors: Sudhir UPADHYAY, Edison, NJ (US); Monik Raj BEHERA, New York, NY (US); Palka PATEL, West Hartford, CT (US); Alexander LITTLETON, Chicago, IL (US); Sophia WASSERMAN, Manhattan, NY (US); Ker Fran LEE, New York, NY (US); Ahmed ELHASSAN, Manhattan, NY (US); Senthil NATHAN, Parsippany, NJ (US); Sudha PRIYADARSHINI, New York, NY (US); Arjun ACHARYA, New York, NY (US)

(21) Appl. No.: 17/654,450

(22) Filed: Mar. 11, 2022

(30) Foreign Application Priority Data
Sep. 20, 2021 (IN) 202111042412

(51) Int. Cl. G06Q 20/40; G06F 21/62; G06N 20/00

(52) U.S. Cl. CPC G06Q 20/4016; G06F 21/6218; G06N 20/00

(57) ABSTRACT

Systems and methods for generating synthetic data using federated, collaborative, privacy preserving learning models are disclosed. In one embodiment, a method for generating synthetic data from real data for use in a federated learning network may include: (1) conducting, by a backend for a first institution of a plurality of institutions in a federated learning network, a transaction comprising transaction data; (2) generating, by the backend for the first institution, local synthetic data for the transaction data using a local synthetic data generating model; (3) sharing, by the backend for the first institution, the local synthetic data with a plurality of backends for other institutions; (4) receiving, by the backend for the first institution, global synthetic data from the plurality of backends for the other institutions; and (5) training, by the backend for the first institution, a local machine learning model with the global synthetic data.

### RELATED APPLICATIONS

This application claims priority to, and the benefit of, Indian Patent Application Number 202111042412, filed Sep. 20, 2021, the disclosure of which is hereby incorporated, by reference, in its entirety.

### BACKGROUND OF THE INVENTION

### 1. Field Of The Invention

Embodiments generally relate to systems and methods for generating synthetic data using federated, collaborative, privacy preserving learning models.

### 2. Description Of The Related Art

Banks, Financial institutions (FIs), and other organizations maintain transaction data that includes personal identifiable information (PII), such as names, account numbers, social security numbers, etc. For example, this data may be received over a transaction network.

The banks, FIs, and other organizations, including research institutions, may wish to use their own data, and data from others, to train machine learning models and for other research purposes. Privacy protection laws, regulations, and policies, however, prevent banks and financial institutions from using their own customer data for training machine learning models.

### SUMMARY OF THE INVENTION

Systems and methods for generating synthetic data using federated, collaborative, privacy preserving learning models are disclosed. In one embodiment, a method for generating synthetic data from real data for use in a federated learning network may include: (1) conducting, by a backend for a first institution of a plurality of institutions in a federated learning network, a transaction comprising transaction data; (2) generating, by the backend for the first institution, local synthetic data for the transaction data using a local synthetic data generating model; (3) sharing, by the backend for the first institution, the local synthetic data with a plurality of backends for other institutions; (4) receiving, by the backend for the first institution, global synthetic data from the plurality of backends for the other institutions; and (5) training, by the backend for the first institution, a local machine learning model with the global synthetic data.

In one embodiment, the transaction may be conducted over a payment network.

In one embodiment, the local synthetic data generating model may include a generative adversarial network.

In one embodiment, the local synthetic data and the global synthetic data do not include personal identifiable information.

In one embodiment, the local machine learning model may include a fraud detection model.

In one embodiment, the backend for the first institution creates intelligent services using the global synthetic data, wherein the intelligent services comprise anomaly detection, fraud detection, payment trend prediction, payment volume prediction, and/or chat bot enhancement.

According to another embodiment, a method for generating synthetic data from real data for use in a federated learning network may include: (1) conducting, by a backend for a first institution of a plurality of institutions in a federated learning network, a transaction comprising transaction data; (2) generating, by the backend for the first institution, local synthetic data for the transaction data using a local synthetic data generating model; (3) providing, by the backend for the first institution, the local synthetic data to a trusted entity, wherein the trusted entity is configured to generate global synthetic data from the local synthetic data from the plurality of institutions; (4) receiving, by the backend for the first institution, the global synthetic data from the trusted entity; and (5) training, by the backend for the first institution, a local machine learning model with the global synthetic data.

In one embodiment, the transaction may be conducted over a payment network.

In one embodiment, the local synthetic data generating model may include a generative adversarial network.

In one embodiment, the local synthetic data and the global synthetic data do not include personal identifiable information.

In one embodiment, the local machine learning model may include a fraud detection model.

In one embodiment, the backend for the first institution may create intelligent services using the global synthetic data, wherein the intelligent services comprise anomaly detection, fraud detection, payment trend prediction, payment volume prediction, and/or chat bot enhancement.

According to another embodiment, a method for generating synthetic data from real data for use in a federated learning network may include: (1) conducting, by a backend for a first institution of a plurality of institutions in a federated learning network, a transaction comprising transaction data; (2) generating, by the backend for the first institution, local synthetic data for the transaction data using a local synthetic data generating model; (3) training, by the backend for the first institution, a local machine learning model with the local synthetic data; (4) providing, by the backend for the first institution, the local machine learning model or parameters for the local machine learning model to a trusted entity, wherein the trusted entity is configured to receive a plurality of local machine learning models or parameters for the plurality of local machine learning models from the plurality of institutions and aggregate the local machine learning models or parameters for the local machine learning models; (5) receiving, by the backend for the first institution, an aggregated machine learning model or parameters for the aggregated machine learning model from the trusted entity; and (6) training, by the backend for the first institution, the local machine learning model with the aggregated machine learning model or parameters for the aggregated machine learning model.

In one embodiment, the transaction may be conducted over a payment network.

In one embodiment, the local synthetic data generating model may include a generative adversarial network.

In one embodiment, the local synthetic data does not include personal identifiable information.

In one embodiment, the local machine learning model may include a fraud detection model.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for generating synthetic data using federated, collaborative, privacy preserving learning models according to an embodiment;

FIG. 2 depicts a method for generating synthetic data using federated, collaborative, privacy preserving learning models according to an embodiment;

FIG. 3 depicts a system for generating synthetic data using federated, collaborative, privacy preserving learning models according to another embodiment;

FIG. 4 depicts a method for generating synthetic data using federated, collaborative, privacy preserving learning models according to another embodiment;

FIG. 5 depicts a system for generating synthetic data using federated, collaborative, privacy preserving learning models according to another embodiment;

FIG. 6 depicts a method for generating synthetic data using federated, collaborative, privacy preserving learning models according to another embodiment;

FIG. 7 depicts a system for generating synthetic data using federated, collaborative, privacy preserving learning models according to another embodiment; and

FIG. 8 depicts a method for generating synthetic data using federated, collaborative, privacy preserving learning models according to another embodiment.

### DETAILED DESCRIPTION OF PREFERRED EMBODIMENTS

Embodiments may generate statistically similar, privacy preserving synthetic data from real data to train machine learning models.

Embodiments may reduce a collection of customer confidential information to generate synthetic data. Embodiments may reduce the risk of reverse engineering of private data should model details be compromised. Embodiments may increase the variance in underlying data which may enhance machine learning model training. Embodiments may combine federated learning with artificial intelligence and/or machine learning.

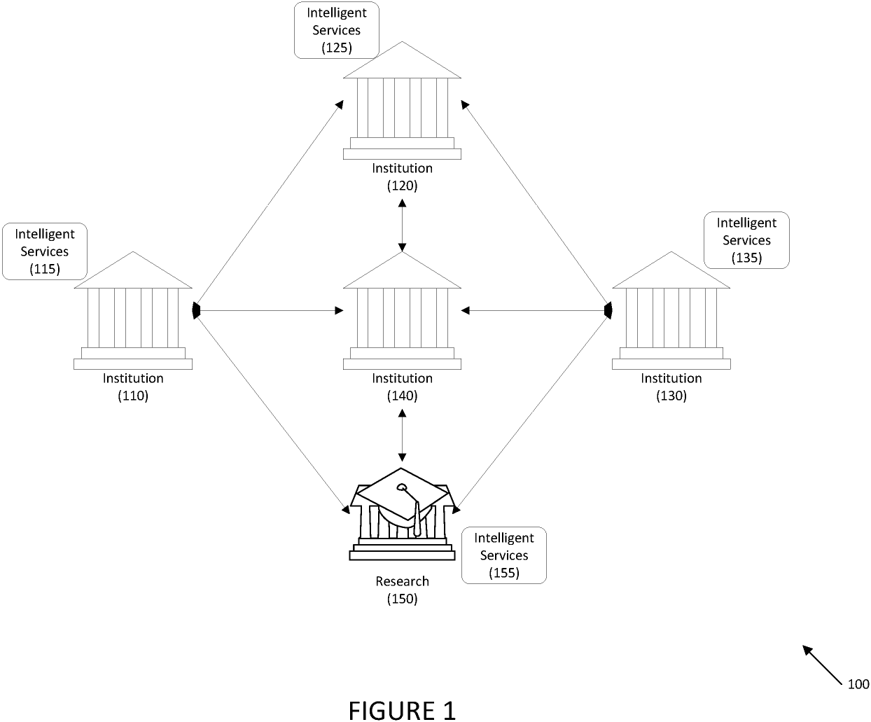

Referring to FIG. 1, a system for generating statistically similar, privacy preserving synthetic data from real data to train machine learning models is provided according to an embodiment. System 100 may include a plurality of institutions 110, 120, 130, 140, and 150 that may be part of a federated learning network. Each institution 110, 120, 130, 140, 150 may include a backend (not shown), such as a server (e.g., cloud and/or physical), computers, etc. that executes operations. As described herein, the actions taken by institutions 110, 120, 130, 140, and 150 may be performed by their respective backends, computer programs executed by the backends, etc.

Institution 140, such as a bank, a financial institution, a research organization, etc. may transact with other institutions, such as institutions 110, 120, and 130, using a communication network, such as a payment network, and may receive real data from those transactions. Institution 140 may then generate synthetic data using the real data from the transactions with institutions 110, 120, and/or 130.

In embodiments, the synthetic data may be generated using a synthetic data generating model, such as a generative adversarial network (GAN) and its variants. Other models may be used as is necessary and/or desired.

Institution 140 may then share the synthetic data with institutions 110, 120, and/or 130 and other institutions, such as research organization 150.

In one embodiment, institutions 110, 120, and 130, and organization 150, may include intelligent services 115, 125, 135, and 155, respectively. Intelligent services 115, 125, 135, and 155 may receive the synthetic data from institution 140 and create, update, or revise machine learning models or other intelligent services for the respective entity. Intelligent services 115, 125, 135, and/or 155 may also perform anomaly detection, fraud detection, payment trend prediction, payment volume prediction, chat bot enhancements, etc.

In one embodiment, the learning at each node may be centralized, or it may be decentralized.

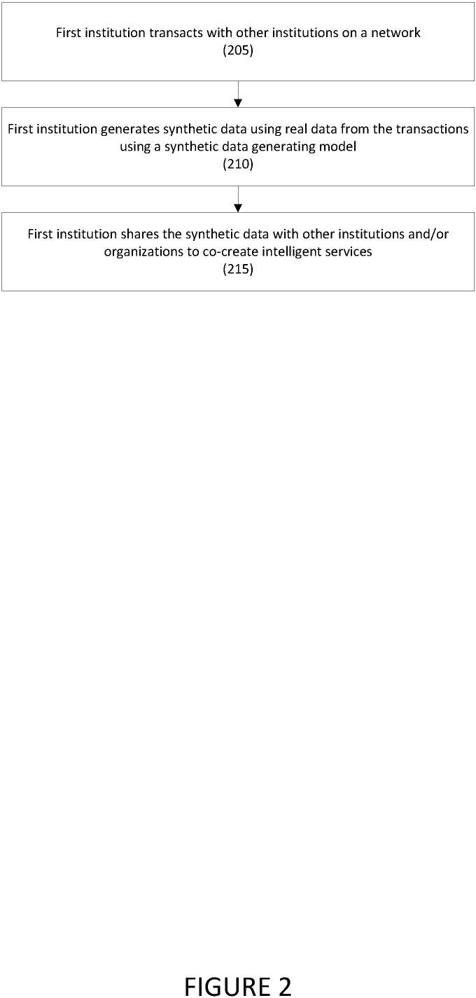

Referring to FIG. 2, a method for generating statistically similar, privacy preserving synthetic data from real data to train machine learning models is provided according to an embodiment.

In step 205, a first institution, such as a financial institution, may transact with one or more other institution, within a network, such as a payment network, and may receive transaction data as a result of the transaction. In one embodiment, the transaction data may include personal or private information, such as customer names, addresses, account numbers, transaction amounts, etc.

In step 210, the first institution may generate synthetic information from the real data in the transactions using, for example, a local synthetic data generating model. An example of a suitable machine learning model is a GAN. Other models may be used as is necessary and/or desired.

In step 215, the first institution may share the generated synthetic data with one or more of the other institutions and/or organizations, such as research organizations. The other institutions and/or organizations may use the synthetic data to co-create intelligent services, train local machine learning models, etc. Examples of services may include fraud detection services, Know Your Customer (KYC) related services, settlement related services, market services, etc. The services may be co-created by a plurality of institutions or organizations, or they may be individually created.

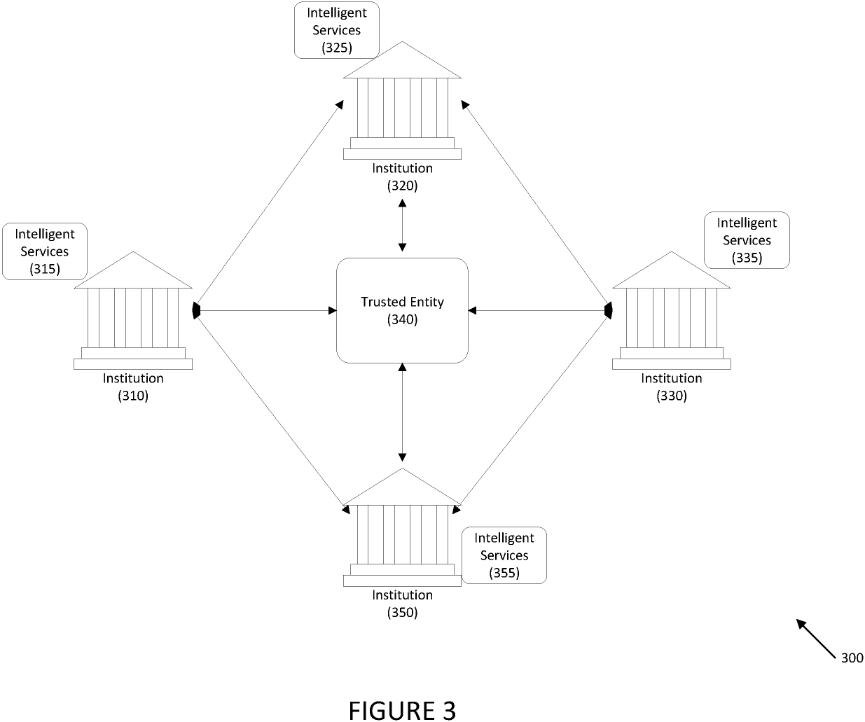

Referring to FIG. 3, a system for generating statistically similar, privacy preserving synthetic data from real data to train machine learning models is provided according to another embodiment. System 300 may include institutions 310, 320, 330, and 350, and trusted entity 340 that may be part of a federated learning network. Institutions 310, 320, 330, and 350 may be financial institutions or any other suitable institution. Each institution 310, 320, 330, and 350 may be provided with intelligent services 315, 325, 335, and 355, respectively.

Each institution 310, 320, 330, 350 and trusted entity 340 may include a backend (not shown). As described herein, the actions taken by institutions 310, 320, 330, and 350, and trusted entity 340, may be performed by the backend, a computer program executed by the backend, etc.

Institutions 310, 320, 330, and/or 350 may conduct transactions on one or more networks that may include transaction data. The transaction data may include personal or private information. Using intelligent services 315, 325, 335, and 355, institutions 310, 320, 330, and/or 350 may generate local synthetic data using local synthetic data generating models, and may communicate their local synthetic data to trusted entity 340. Examples of synthetic data generating models may include Privacy Preserving GAN models, Generative models with Bayesian networks, etc.

Trusted entity 340 may be another institution, or it may be a different entity, such as an aggregator, a FinTech provider, an unbiased entity, the open source community, etc. Trusted entity 340 may use the local synthetic data received from institutions 310, 320, 330, and/or 350 and may generate global synthetic data using, for example, a synthetic data generating model (e.g., GAN or a suitable machine learning model). Trusted entity 340 may then return the global synthetic data to institutions 310, 320, 330, and/or 350 for processing by intelligent services 315, 325, 335, and 355, respectively, to train local machine learning models, etc.

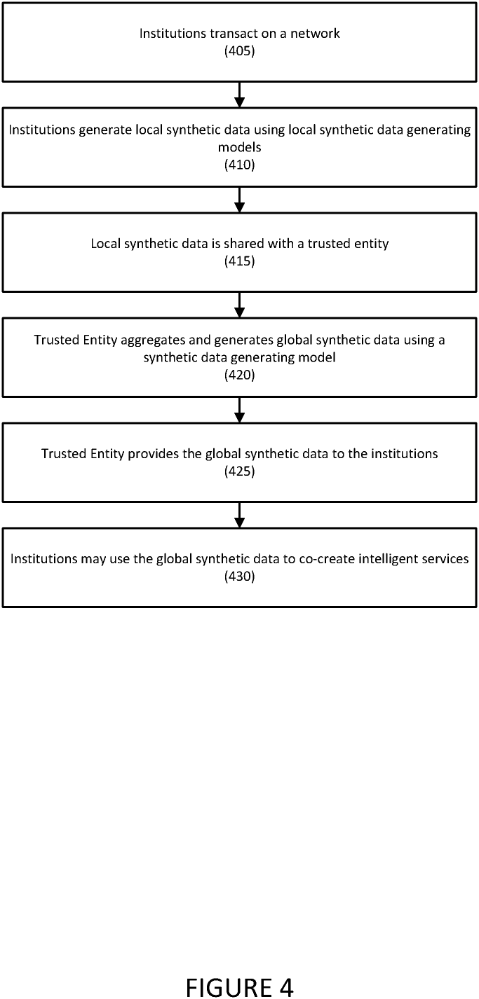

Referring to FIG. 4, a method for generating statistically similar, privacy preserving synthetic data from real data to train machine learning models is provided according to an embodiment. In step 405, a plurality of institutions, such as financial institutions, may conduct transactions on one or more networks, such as a payment network. The transactions may include real data, such as personal or private information.

In step 410, the institutions may generate local synthetic data using the real data using local synthetic data generating models.

In step 415, the institutions may provide the local synthetic data to a trusted entity. The trusted entity may be another institution, or it may be a different entity, such as an aggregator, a FinTech provider, etc.

In step 420, the trusted entity may generate global synthetic data using the local synthetic data received from the institutions using, for example, a synthetic data generating model (e.g., GAN or a suitable machine learning model).

In step 425, the trusted entity may provide the global synthetic data to the institutions, and in step 430, the institutions may use the global synthetic data to co-create intelligent services, to train local machine learning models, etc.

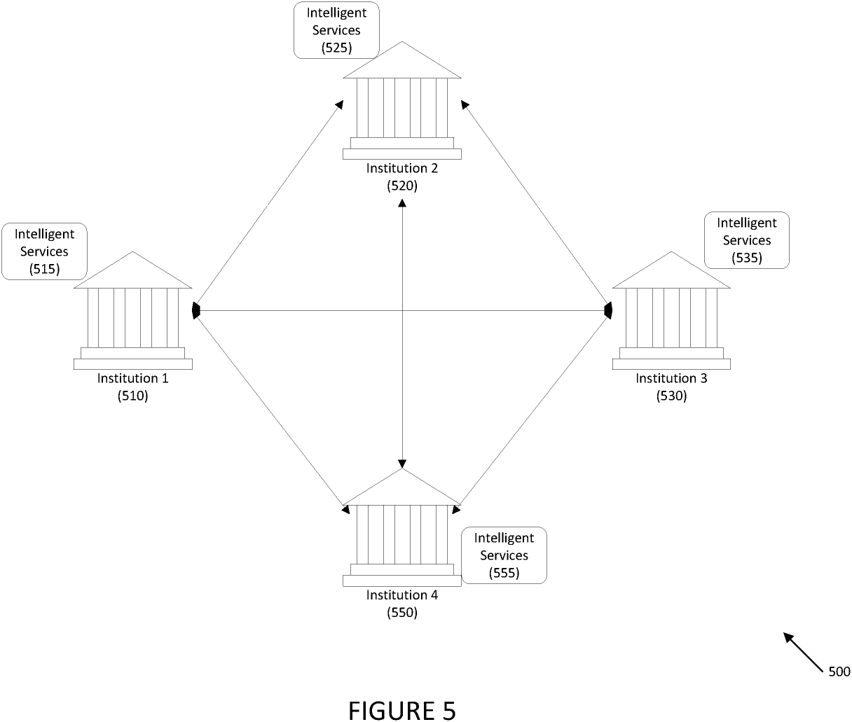

Referring to FIG. 5, a system for generating statistically similar, privacy preserving synthetic data from real data to train machine learning models is provided according to another embodiment. System 500 may include institutions 510, 520, 530, and 550 that may be part of a federated learning network. Institutions 510, 520, 530, and 550 may be financial institutions or any other suitable institution. Each institution 510, 520, 530, and 550 may be provided with intelligent services 515, 525, 535, and 555, respectively.

Each institution 510, 520, 530, 550 may include a backend (not shown). As described herein, the actions taken by institutions 510, 520, 530, and 550 may be performed by the backend, a computer program executed by the backend, etc.

Institutions 510, 520, 530, and/or 550 may conduct transactions on one or more networks that may include transaction data. The transaction data may include personal or private information. Using intelligent services 515, 525, 535, and 555, institutions 510, 520, 530, and/or 550 may generate local synthetic data using local synthetic data generating models. Institutions 510, 520, 550, and/or 550 may then exchange their local synthetic data with each other. Intelligent services 515, 525, 535, and 555 for institutions 510, 520, 530, and/or 550 may then use the synthetic data from the other institutions to train local machine learning models, etc.

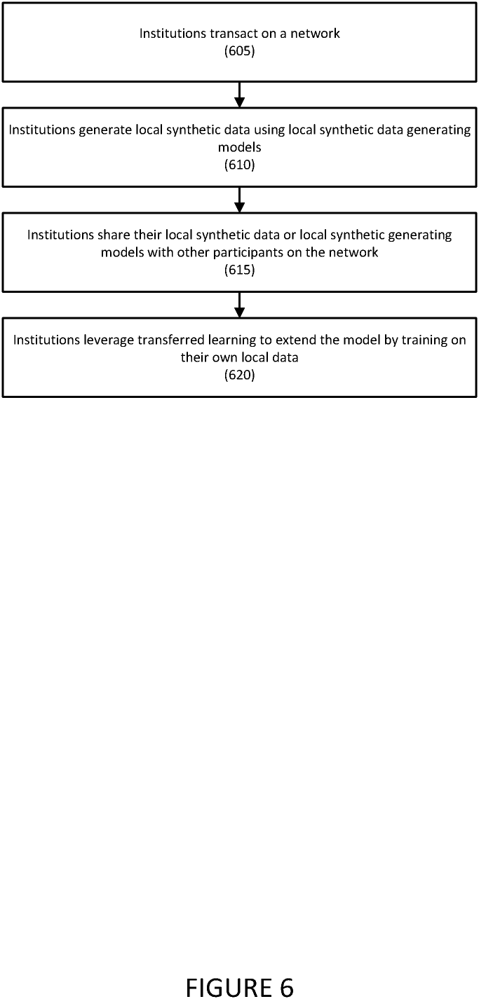

Referring to FIG. 6, a method for generating statistically similar, privacy preserving synthetic data from real data to train machine learning models is provided according to an embodiment. In step 605, a plurality of institutions, such as financial institutions, may conduct transactions on one or more networks, such as a payment network. The transactions may include real data, such as personal or private information.

In step 610, the institutions may generate local synthetic data using the real data using local synthetic data generating models. In one embodiment, the institutions may also train local machine learning engines with the synthetic data and/or the transaction data.

In step 615, the institutions may exchange their local synthetic data and/or locally trained models or parameters for their local machine learning models (e.g., model weights) with each other.

In step 620, the institutions may use the global synthetic data to co-create intelligent services, to train local machine learning models, etc.

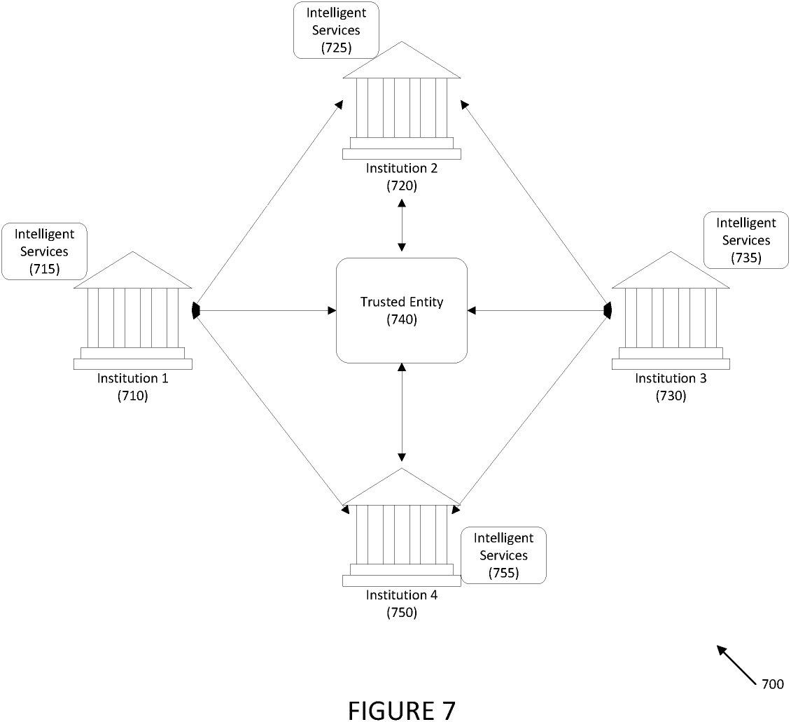

Referring to FIG. 7, a system for generating statistically similar, privacy preserving synthetic data from real data to train machine learning models is provided according to another embodiment. System 700 may include institutions 710, 720, 730, and 750, and trusted entity 740, that may be part of a federated learning network. Institutions 710, 720, 730, and 750 may be financial institutions or any other suitable institution. Each institution 710, 720, 730, and 750 may be provided with intelligent services 715, 725, 735, and 755, respectively.

Each institution 710, 720, 730, 750 and trusted entity 740 may include a backend (not shown). As described herein, the actions taken by institutions 710, 720, 730, and 750, and trusted entity 740, may be performed by the backend, a computer program executed by the backend, etc.

Institutions 710, 720, 730, and/or 750 may conduct transactions on one or more networks that may include transaction data. The transaction data may include personal or private information. Using intelligent services 715, 725, 735, and 755, institutions 710, 720, 730, and/or 750 may generate local synthetic data using local synthetic data generating models, and may train the local machine learning models, etc. Institutions 710, 720, 730, and/or 750 may share their local machine learning models and/or their model weights with trusted entity 740.

Trusted entity 740 may be another institution, or it may be a different entity, such as an aggregator, a FinTech provider, an unbiased entity, the open -source community, a research organization, etc. Trusted entity 740 may use the local machine learning models received from institutions 710, 720, 730, and/or 750 and may aggregate the local machine learning models into an aggregated machine learning model. Trusted entity 740 may then return the aggregated machine learning model to institutions 710, 720, 730, and/or 750 for processing by intelligent services 715, 725, 735, and 755, respectively, to retrain their local machine learning models, etc.

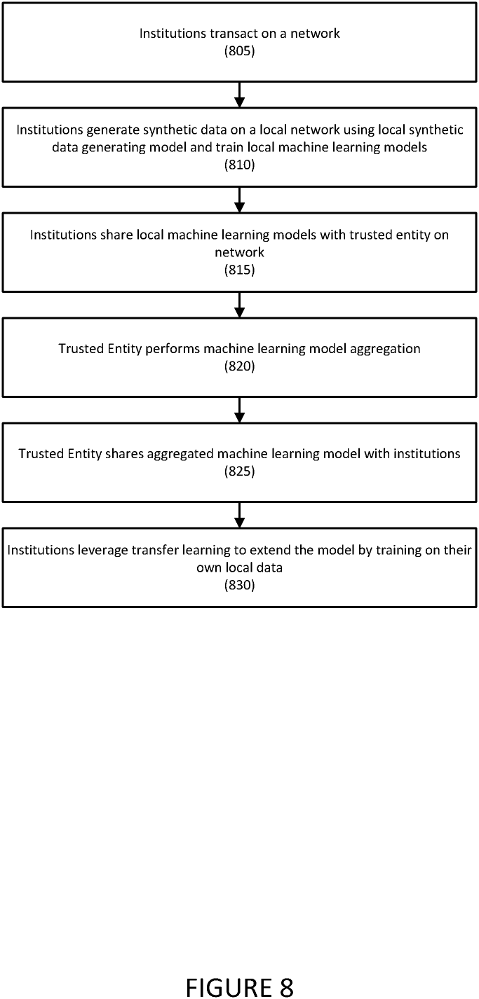

Referring to FIG. 8, a method for generating statistically similar, privacy preserving synthetic data from real data to train machine learning models is provided according to an embodiment. In step 805, a plurality of institutions, such as financial institutions, may conduct transactions on one or more networks, such as a payment network. The transactions may include real data, such as personal or private information.

In step 810, the institutions may generate local synthetic data using the real data using local synthetic data generating models. In one embodiment, the institutions may also train local machine learning models with the synthetic data and/or the transaction data.

In step 815, the institutions may communicate their local machine learning models or parameters for the local machine learning models (e.g., model weights) to a trusted entity.

In step 820, the trusted entity may perform aggregation on the machine learning model, and in step 825, may share the aggregated machine learning model with the institutions. Aggregation may be performed using any suitable technique, such as Federated Averaging (FedAvg), Federated stochastic gradient descent (FedSGD), etc.

In step 830, the institutions may use the global synthetic data to co-create intelligent services, to train local machine learning models, etc.

Although several embodiments have been disclosed, the embodiments are not exclusive, and features disclosed in one embodiment may be used with other embodiments.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler, or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be a non-transitory medium in the form of a compact disc, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for generating synthetic data from real data for use in a federated learning network, comprising:
conducting, by a backend for a first institution of a plurality of institutions in a federated learning network, a transaction comprising transaction data;
generating, by the backend for the first institution, local synthetic data for the transaction data using a local synthetic data generating model;
sharing, by the backend for the first institution, the local synthetic data with a plurality of backends for other institutions;
receiving, by the backend for the first institution, global synthetic data from the plurality of backends for the other institutions; and
training, by the backend for the first institution, a local machine learning model with the global synthetic data.

2. The method of claim 1, wherein the transaction is conducted over a payment network.

3. The method of claim 1, wherein the local synthetic data generating model comprises a generative adversarial network.

4. The method of claim 1, wherein the local synthetic data and the global synthetic data do not include personal identifiable information.

5. The method of claim 1, wherein the local machine learning model comprises a fraud detection model.

6. The method of claim 1, wherein the backend for the first institution creates intelligent services using the global synthetic data, wherein the intelligent services comprise anomaly detection, fraud detection, payment trend prediction, payment volume prediction, and/or chat bot enhancement.

7. A method for generating synthetic data from real data for use in a federated learning network, comprising:
conducting, by a backend for a first institution of a plurality of institutions in a federated learning network, a transaction comprising transaction data;
generating, by the backend for the first institution, local synthetic data for the transaction data using a local synthetic data generating model;
providing, by the backend for the first institution, the local synthetic data to a trusted entity, wherein the trusted entity is configured to generate global synthetic data from the local synthetic data from the plurality of institutions;
receiving, by the backend for the first institution, the global synthetic data from the trusted entity; and
training, by the backend for the first institution, a local machine learning model with the global synthetic data.

8. The method of claim 7, wherein the transaction is conducted over a payment network.

9. The method of claim 7, wherein the local synthetic data generating model comprises a generative adversarial network.

10. The method of claim 7, wherein the local synthetic data and the global synthetic data do not include personal identifiable information.

11. The method of claim 7, wherein the local machine learning model comprises a fraud detection model.

12. The method of claim 7, wherein the backend for the first institution creates intelligent services using the global synthetic data, wherein the intelligent services comprise anomaly detection, fraud detection, payment trend prediction, payment volume prediction, and/or chat bot enhancement.

13. A method for generating synthetic data from real data for use in a federated learning network, comprising:
conducting, by a backend for a first institution of a plurality of institutions in a federated learning network, a transaction comprising transaction data;
generating, by the backend for the first institution, local synthetic data for the transaction data using a local synthetic data generating model;
training, by the backend for the first institution, a local machine learning model with the local synthetic data;
providing, by the backend for the first institution, the local machine learning model or parameters for the local machine learning model to a trusted entity, wherein the trusted entity is configured to receive a plurality of local machine learning models or parameters for the plurality of local machine learning models from the plurality of institutions and aggregate the local machine learning models or parameters for the local machine learning models;
receiving, by the backend for the first institution, an aggregated machine learning model or parameters for the aggregated machine learning model from the trusted entity; and
training, by the backend for the first institution, the local machine learning model with the aggregated machine learning model or parameters for the aggregated machine learning model.

14. The method of claim 13, wherein the transaction is conducted over a payment network.

15. The method of claim 13, wherein the local synthetic data generating model comprises a generative adversarial network.

16. The method of claim 13, wherein the local synthetic data does not include personal identifiable information.

17. The method of claim 13, wherein the local machine learning model comprises a fraud detection model.
